(19) United States
(12) Patent Application Publication
(10) Pub. No.: US 2015/0116241 A1
(43) Pub. Date: Apr. 30, 2015

(54) DATA DISPLAY METHOD AND ELECTRONIC DEVICE THEREOF

(71) Applicants: BEIJING LENOVO SOFTWARE LTD., Beijing (CN); LENOVO (BEIJING) LIMITED, Beijing (CN)

(72) Inventors: Qing LIU, Beijing (CN); Xiang SHAO, Beijing (CN); Qi LI, Beijing (CN); Jinping YANG, Beijing (CN)

(73) Assignees: LENOVO (BEIJING) LIMITED, Beijing (CN); BEIJING LENOVO SOFTWARE LTD., Beijing (CN)

(21) Appl. No.: 14/491,325

(22) Filed: Sep. 19, 2014

(30) Foreign Application Priority Data
Oct. 24, 2013 (CN) 201310507852.5

(51) Int. Cl. G06F 21/60; G09G 5/12

(52) U.S. Cl. CPC G06F 21/606; G09G 5/12; G09G 2354/00; G09G 2358/00
USPC 345/173

(57) ABSTRACT

A data display method and an electronic device thereof are provided by the invention to address the technical problem in the prior art of the low security for displaying data due to the indistinguishable data display of the electronic device. The method is applied in an electronic device. The electronic device comprises a display unit and a touch unit. The electronic device is able to communicate data with an electronic accessory and there are public data and private data corresponding to the electronic accessory. The method comprises steps of verifying the electronic accessory when the electronic accessory has been attached on the surface of the touch unit; controlling the display unit to display both the public data and the private data if the verification is successful; and controlling the display unit to display only the public data if the verification is not successful.

### TECHNICAL FIELD

The invention relates to the field of electronic technique, in particular, to a data display method and an electronic device thereof.

### BACKGROUND

With the development of the science and technique, more and more electronic devices (such as smart phone, normal tablet computer, desktop tablet computer, notebook, intelligent television, and so on) have come into our daily lives. These electronic devices have brought great convenience to our lives.

Nowadays a same user may use different tablet computers at different locations. For example, a user may use a personal computer for viewing data at home, may use an office computer for viewing data in the office, and may use a public computer for viewing data at a public place. Nevertheless, no matter the user uses which computer at which place, the electronic device displays related contents according to the operations of the user so that those contents can be viewed by the user.

However, the inventor of the invention found at least the following technical defects in the above described solution during the implementation of the embodiments of the invention.

When a user uses an electronic device viewing his/her private data such as bank account, personal mails, etc, especially at a public place, those data may also be viewed by other users though the display unit of the electronic device. Thereby those data may be peeped, and thus there is a technical problem of the low security for displaying data due to the indistinguishable data display of the electronic device.

### SUMMARY

A data display method and an electronic device thereof are provided by the invention to address the technical problem of the low security for displaying data due to the indistinguishable data display of the electronic device, which can improve the security of the data upon displaying.

With respect to an aspect, an embodiment of the application provides a data display method which applies to an electronic device comprising a display unit and a touch unit, the electronic device being able to communicate data with an electronic accessory, there being public data and private data corresponding to the electronic accessory, the method comprising: verifying the electronic accessory when the electronic accessory has been attached on the surface of the touch unit; if the verification is successful, controlling the display unit to display both the public data and the private data; and if the verification is not successful, controlling the display unit to display only the public data.

Optionally, verifying the electronic accessory particularly comprises: obtaining an accessory identity of the electronic accessory by coupling the touch unit with the electronic accessory; matching the accessory identity of the electronic accessory with a device identity of the electronic device based on the correspondences between accessory identities and device identities, wherein the verification for the electronic accessory is passed when the accessory identity of the electronic accessory successfully matches with the device identity of the electronic device, and the verification for the electronic accessory is not passed when the accessory identity of the electronic accessory does not successfully match with the device identity of the electronic device.

Optionally, after controlling the display unit to display only the public data, the method further comprises: obtaining a user operation; and controlling the display unit to display the private data when the user operation meets a predefined condition.

Optionally, controlling the display unit to display both the public data and the private data particularly comprises: according to an attachment location where the electronic accessory is attached to the touch unit, controlling the display unit to display both the public data and the private data in a first area containing the attachment location.

Optionally, controlling the display unit to display only the public data particularly comprises: controlling the display unit to display only the public data in the first area according to the attachment location.

With respect to another aspect, an embodiment of the invention provides an electronic device comprising a display unit and a touch unit, the electronic device being able to communicate data with an electronic accessory, there being public data and private data corresponding to the electronic accessory, the electronic device further comprising: a verification unit configured for verifying the electronic accessory when the electronic accessory has been attached on the surface of the touch unit; and a control unit configured for, if the verification is successful, controlling the display unit to display both the public data and the private data; and if the verification is not successful, further controlling the display unit to display only the public data.

Optionally, the verification unit is particularly configured for: obtaining an accessory identity of the electronic accessory by coupling the touch unit with the electronic accessory; matching the accessory identity of the electronic accessory with a device identity of the electronic device based on the correspondences between accessory identities and device identities, wherein the verification for the electronic accessory is passed when the accessory identity of the electronic accessory successfully matches with the device identity of the electronic device, and the verification for the electronic accessory is not passed when the accessory identity of the electronic accessory does not successfully match with the device identity of the electronic device.

Optionally, the electronic device further comprises an operation obtaining unit configured for, after controlling the display unit to display only the public data, obtaining a user operation; and the control unit is further configured for controlling the display unit to display the private data when the user operation meets a predefined condition.

Optionally, the control unit is particularly configured for, according to an attachment location where the electronic accessory is attached to the touch unit, controlling the display unit to display both the public data and the private data in a first area containing the attachment location.

Optionally, the control unit is particularly configured for controlling the display unit to display only the public data in the first area according to the attachment location.

The one or more technical solutions provided by the embodiments of the application at least have the following technical effects or advantages:
An electronic device may be able to communicate data with an electronic accessory and there are public data and private data corresponding to the electronic accessory. As such, when the user uses the electronic device such as a desktop tablet computer, he or she only needs to attach the electronic accessory on the surface of the touch unit of the electronic device. At this time, when the electronic accessory has been attached on the surface of the touch unit, the electronic device verifies the electronic accessory, and if the verification is successful, controls a display unit to display both the public data and the private data, otherwise controls the display unit to display only the public data. Therefore, when an unmatched electronic accessory has been attached on the electronic device, the electronic device will not display the private data corresponding to the electronic accessory so as to prevent the private data from being peeped, efficiently address the technical problem in the prior art of the low security for displaying data due to the indistinguishable data display of the electronic device, improve the security of the data upon displaying and provide a good user experience.

### BRIEF DESCRIPTION OF THE DRAWINGS

FIG. 1 is a method flow for displaying data according to an embodiment of the invention;

FIGS. 2a-2c are the illustrative diagrams of the first area according to an embodiment of the invention; and

FIG. 3 is a functional block diagram of the electronic device according to an embodiment of the invention.

### DETAILED DESCRIPTION

An embodiment of the invention provides an electronic device, which addresses the technical problem in the prior art of the low security for displaying data due to the indistinguishable data display of the electronic device, improves the security of the data upon displaying, and provides a good user experience.

In order to address the above technical problem of the low security for displaying data due to the indistinguishable data display of the electronic device, the solutions of embodiments of the application are of the general idea as below:
An electronic device may be able to communicate data with an electronic accessory and there are public data and private data corresponding to the electronic accessory. As such, when a user uses the electronic device such as a desktop tablet computer, he or she needs to attach the electronic accessory on the surface of the touch unit of the electronic device. At this time, when the electronic accessory has been attached on the surface of the touch unit, the electronic device verifies the electronic accessory, and if the verification is successful, a display unit of the electronic device is controlled to display both the public data and the private data, otherwise the display unit is controlled to display only the public data. Therefore, when an unmatched electronic accessory has been attached on the electronic device, the electronic device will not display the private data so as to prevent the private data from being peeped, efficiently address the technical problem in the prior art of the low security for displaying data due to the indistinguishable data display of the electronic device, improve the security of the data upon displaying and provide a good user experience.

The solutions of the invention will be described below in detail, in connection with the figures and the particular embodiments. It is to be understood that the embodiments and specific features in the embodiments of the present disclosure are detailed illustrations of the technical solutions of the present disclosure, but not limitation to technical solutions of the present disclosure. The embodiments of the present disclosure and the specific features thereof may be combined with each other without any conflict.

In an aspect, an embodiment of the invention provides a data display method which is applied to an electronic device. The electronic device may be any of smart phone, tablet computer, multimedia player, notebook, intelligent television, and so on. The electronic device may comprise a display unit and a touch unit, and preferably, the display unit and the touch unit may be incorporated to form a touch & display unit such as a touch & display screen or a flexible screen.

In the embodiment, the electronic device may be able to communicate data with an electronic accessory, and preferably, the above touch unit may be a capacitive touch screen or a resistive touch screen. Then, when the electronic accessory is attached to a surface of the touch unit, a chip equipped in the electronic accessory can communicate data through the mutual couple with an electrode on the surface of the touch unit.

Preferably, each electronic accessory may hold an accessory identity which uniquely identifies itself.

Optionally, a client of the electronic accessory may be installed on the electronic device, by which the user can configure the data corresponding to the electronic accessory and perform a pairing configuration between the electronic device and the electronic accessory.

Particularly, the user may run the client of the electronic accessory on the electronic device where the client was installed, and upload data to a server for the electronic accessory. Furthermore, the data needed to be uploaded will be classified into the public data and the private data and this setting will be saved, by which the server will save the data uploaded by the user according to its category after the data has been uploaded to the server. For example, the public data may be electronic magazines, web page documents, business cards of a few contacts, application icons, etc.; and the private data may be personal pictures, personal related information, business cards of the private contacts, login username and password of the client, etc. The invention is not limited in this respect.

In another embodiment, when the user first attaches the electronic accessory on the touch unit of the electronic device, the touch unit detects the electronic accessory, and automatically pops up a dialog box inquiring the user “whether to pair the electronic accessory with the electronic device?” In case the user currently uses his/her own personal electronic device, the user may choose “yes”, or if the user currently uses a public electronic device, the user may choose “no.” The electronic device may acquire the accessory identity of the electronic accessory, and store it in the client of the electronic accessory or the electronic device in association with the device identity of the electronic device which uniquely identifies the electronic device, such as the physical address, the network card number, etc. In other words, the correspondence between the accessory identity of the electronic accessory and the device identity of the electronic device may be saved in the client or the electronic device. Of course, the correspondence may also be uploaded to a server. The invention is not limited in this respect.

In a particular implementation, the correspondence between the accessory identity and the device identity may be stored in the form of a table, as shown below by Table 1.

TABLE 1

| Accessory | Device Identity |
|---|---|
| Identity | (physical address) |
| 001 | 00-10-5C-AD-72-E3 |
| 005 | 00-25-14-89-54-23 |

In a practical implementation, the correspondence between the accessory identity and the device identity may be stored in other forms, as long as they are stored in association with each other. The invention is not limited in this respect.

It should be explained that the data corresponding to the electronic accessory may also be stored in the storage unit of the electronic device, in addition to be stored in the server for the electronic accessory as described above. If the amount of the data is small (for example, several characters or a document), it may be stored in the storage unit on the electronic accessory. The invention is not limited in this respect.

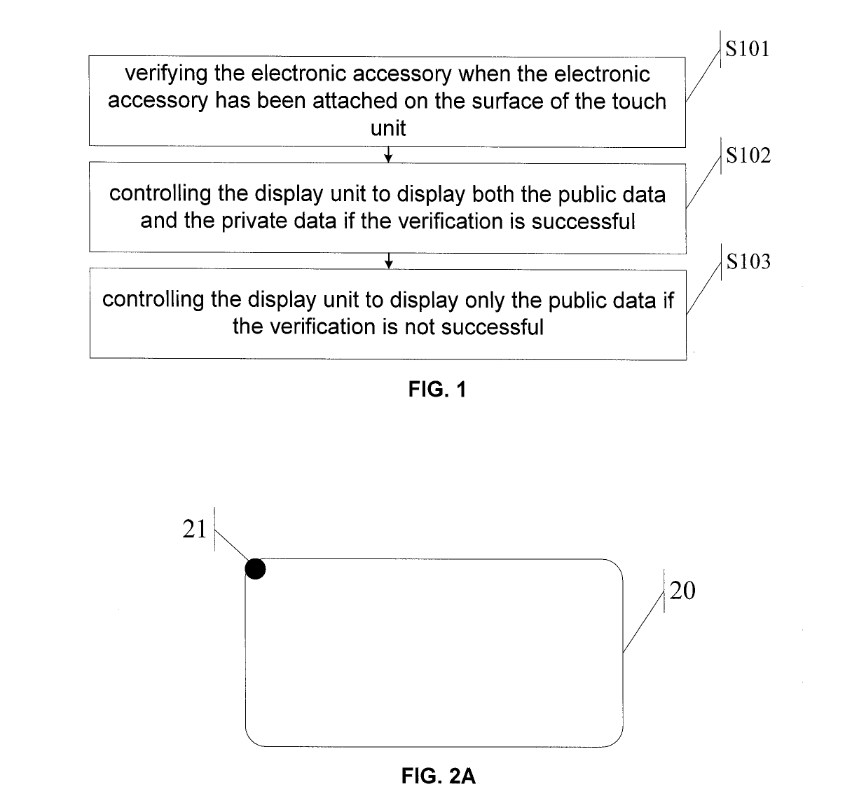

Then, referring to FIG. 1, the above data display method comprises the following steps:

S101: verifying the electronic accessory when the electronic accessory has been attached on the surface of the touch unit;

S102: if the verification is successful, controlling the display unit to display both the public data and the private data;

S103: if the verification is not successful, controlling the display unit to display only the public data.

The above technical solution will be explained by the following instances.

For example, when the user attaches his/her electronic accessory with an accessory identity 001 on his/her personal tablet computer used at home with a physical address 00-10-5C-AD-72-E3, S101 is performed. At this time, the electronic device can detect the contact between the electronic accessory and the touch unit, and verifies the electronic accessory.

Particularly, data can be communicated from the electronic accessory to the electronic device to obtain the accessory identity of the electronic accessory (i.e. accessory identity 001) by coupling the touch unit with the electronic accessory. Then, matching between the accessory identity of the electronic accessory and the device identity of the electronic device is verified based on the correspondences between the accessory identities and the device identities as shown in FIG. 1. That is, whether the electronic accessory attached on the surface of the touch unit is matched with the electronic device may be determined according to the correspondences between the accessory identities and the device identities stored in the client of the electronic accessory or the server. In case the accessory identity of the electronic accessory is matched with the device identity of the electronic device, the verification of the electronic accessory is successful; whereas in case the accessory identity of the electronic accessory is not matched with the device identity of the electronic device, the verification of the electronic accessory is failed.

It can be seen from Table 1 that the electronic accessory 001 is matched with the personal tablet computer currently used by the user (i.e. the verification of the electronic accessory is successful), then S102 is performed. That is, if the verification is successful, the display unit is controlled to display both the public data and the private data.

Particularly, when the verification of the electronic accessory is successful, the electronic device, according to the attachment location where the electronic accessory is attached to the touch unit (i.e. the location on the surface of the touch unit where the charges are changed), controls the display unit to display both the public data and the private data in a first area containing the attachment location.

It should be explained that in case the private data are the login name and password for the user to log in an application client, the first area contains input areas for the login name and the password for the respective client. Then, the display unit is controlled to display the public data in the first area, and to automatically fill the private data (i.e. the login name and the password) in the above input areas.

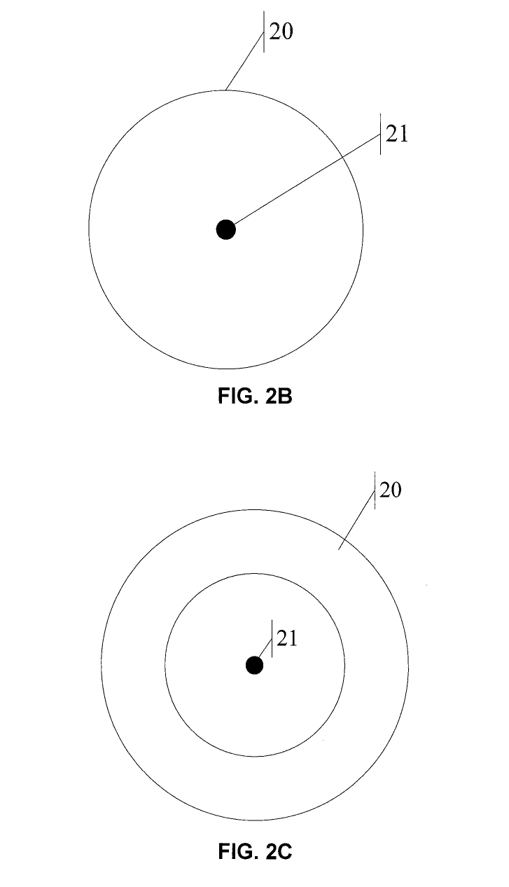

In the embodiment, the first area 20 may, as shown in FIG. 2A, be a rectangular area taking the attachment location 21 as a vertex, or as shown in FIG. 2B, be a rounded area taking the attachment location 21 as a center, or as shown in FIG. 2C, be a annulated area taking the attachment location 21 as a center. Of course, there may be other ways for displaying the first area 20. The invention is not limited in this respect.

In another embodiment, the user currently is using a public computer with a physical address 00-25-14-89-54-23. Then, after the user attaches an electronic accessory with an accessory identity 001 on the surface of the touch unit, according to the above Table 1, verification of the matching between the accessory identity and the device identity is failed, i.e. the verification of the electronic accessory is not successful.

Now S103 is performed, i.e. if the verification is not successful, the display unit is controlled to display only the public data.

Particularly, the display unit is controlled to display only the public data in the first area according to the attachment location where the electronic accessory is attached to the touch unit.

Furthermore, if the user confirms that the usage environment is safe, or if the user must view the private data, the user may perform a certain user operation on the electronic accessory, the electronic device or the client. At this time, the electronic device judges whether a preset condition is met according to the obtained user operation. When the user operation meets the preset condition, the display unit is controlled to display the private data.

For example, when the user taps the electronic accessory, the charges at the attachment location are changed, from which the electronic device can identify the strength and the rhythm of the tap the user applied on the electronic accessory so as to judge whether the user operation meets a preset condition (i.e. a preset tapping rule) or not. Or the user may perform a gesture operation on the touch unit (such as circling clockwise, sliding to the left, and so on) while the display unit displays only the public data. The electronic device may obtain the gesture operation and judge whether it meets a preset condition or not, i.e. whether it is a preset gesture operation or not. Moreover, the user may run a client, and input a unlock password on an interface which is provided by the client for inputting the unlock password. The electronic device may obtain this input operation of the user, identify the unlock password inputted by the user, and judge whether the unlock password inputted by the input operation of the user is a preset password. When the user operation meets a preset condition, the display unit is controlled to display the private data. Preferably, the private data is displayed in the first area mentioned above according to the attachment location where the electronic accessory is attached to the touch unit.

From above, an electronic device may be able to communicate data with an electronic accessory and there are public data and private data corresponding to the electronic accessory. As such, when the user uses the electronic device such as a desktop tablet computer, he or she only needs to attach the electronic accessory on the surface of the touch unit of the electronic device. At this time, once the electronic accessory is attached on the surface of the touch unit, the electronic device verifies the electronic accessory, and if the verification is successful, the electronic device controls a display unit to display both the public data and the private data, otherwise the electronic device controls the display unit to display only the public data. Therefore, when the electronic accessory attached on the electronic device is not unmatched with the electronic device, the electronic device will not display the private data corresponding to the electronic accessory so as to prevent the private data from being peeped, efficiently address the technical problem in the prior art of the low security for displaying data due to the indistinguishable data display of the electronic device, improve the security of the data upon displaying and provide a good user experience.

With respect to another aspect, an embodiment of the invention provides an electronic device which may be any of smart phone, tablet computer, multimedia player, notebook, intelligent television, and so on. The electronic device may comprise a display unit and a touch unit, and preferably, the display unit and the touch unit may be superposed to form a touch & display unit such as a touch & display screen or a flexible screen.

In the embodiment, the electronic device may be able to communicate data with an electronic accessory.

Preferably, the above touch unit may be a capacitive touch screen or a resistive touch screen. Then, when the electronic accessory is attached to a surface of the touch unit, a chip equipped in the electronic accessory can communicate data with the electronic device through mutual coupling with an electrode on the surface of the touch unit.

Preferably, each electronic accessory may hold an accessory identity which uniquely identifies itself.

Optionally, a client of the electronic accessory may be installed on the electronic device, by which the user can configure the data corresponding to the electronic accessory and perform a pairing configuration between the electronic device and the electronic accessory.

Particularly, the user may run the client of the electronic accessory on the electronic device where the client was installed, and upload data to a server for the electronic accessory. Furthermore, the data needed to be uploaded will be classified into the public data and the private data and this setting will be saved, by which the server will save the data uploaded by the user according to its category after the data has been uploaded to the server. For example, the public data may be electronic magazines, web page documents, business cards of a few the contacts, etc.; and the private data may be personal pictures, personal related information, business cards of the private contacts, login username and password of the client, etc. The invention is not limited in this respect.

In another embodiment, when the user first attaches the electronic accessory onto the touch unit of the electronic device, the touch unit detects the electronic accessory, and automatically pops up a dialog box inquiring the user “whether to pair the electronic accessory with the electronic device?” In case the user currently uses his/her own personal electronic device, the user may choose “yes”, or if the user currently uses a public electronic device, the user may choose “no.” The electronic device may acquire the accessory identity of the electronic accessory, and store it in the client of the electronic accessory or the electronic device in association with the device identity of the electronic device which uniquely identifies the electronic device, such as the physical address, the network card number, etc. In other words, the correspondence between the accessory identity of the electronic accessory and the device identity of the electronic device may be saved in the client or the electronic device. Of course, the correspondence may also be uploaded to a server. The invention is not limited in this respect.

In a particular implementation, the correspondence between the accessory identity and the device identity may be stored in the form of a table, as shown below by Table 1.

TABLE 1

| Accessory | Device Identity |
|---|---|
| Identity | (physical address) |
| 001 | 00-10-5C-AD-72-E3 |
| 005 | 00-25-14-89-54-23 |

In a practical implementation, the correspondence between the accessory identity and the device identity may be stored in other forms, as long as they are stored in association with each other. The invention is not limited in this respect.

It should be explained that the data corresponding to the electronic accessory may also be stored in the storage unit of the electronic device, in addition to be stored in the server for the electronic accessory as described above. If the amount of the data is small (for example, several characters or a document), it may be stored in the storage unit on the electronic accessory. The invention is not limited in this respect.

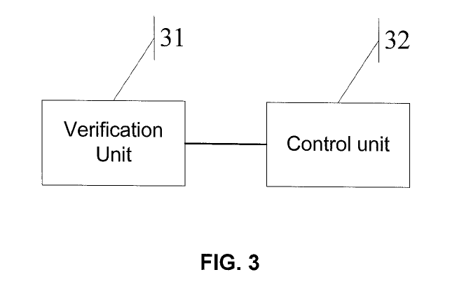

Furthermore, as shown in FIG. 3, the electronic device further comprises: a verification unit 31, for verifying the electronic accessory when the electronic accessory has been attached onto the surface of the touch unit; and a control unit 32 for controlling the display unit to display both the public data and the private data if the verification is successful, and for further controlling the display unit to display only the public data if the verification is not successful.

Furthermore, the verification unit 31 is particularly used for: obtaining an accessory identity of the electronic accessory by coupling the touch unit with the electronic accessory; matching the accessory identity of the electronic accessory with a device identity of the electronic device based on the correspondences between accessory identities and device identities, wherein the verification for the electronic accessory is successful when the accessory identity of the electronic accessory matches with the device identity of the electronic device, and the verification for the electronic accessory is not successful when the accessory identity of the electronic accessory does not match with the device identity of the electronic device.

Additionally, the electronic device further comprises: an operation obtaining unit for, after controlling the display unit to display only the public data, obtaining a certain user operation; and the control unit 32 is further used for controlling the display unit to display the private data when the user operation meets a predefined condition.

Furthermore, the control unit 32 is particularly used for, according to an attachment location where the electronic accessory is attached to the touch unit, controlling the display unit to display both the public data and the private data in a first area containing the attachment location.

Optionally, the control unit 32 is particularly used for controlling the display unit to display only the public data in the first area according to the attachment location.

In the embodiment, the first area 20 may, as shown in FIG. 2A, be a rectangular area taking the attachment location 21 as a vertex, or as shown in FIG. 2B, be a rounded area taking the attachment location 21 as a center, or as shown in FIG. 2C, be a annulated area taking the attachment location 21 as a center. Of course, there may be other ways for displaying the first area 20. The invention is not limited in this respect.

Variation and instances for the data display method as described in the embodiments above may also be applicable to the electronic device of this embodiment. One with ordinary skills in the art may unambiguously know their implementations in the electronic device of this embodiment from the above detailed description of the data display method. Therefore, for the purpose of the briefness of the description, those implementations will be omitted herein.

The above solution in the embodiments of the application at least have the following technical effects or advantages:
An electronic device may be able to communicate data with an electronic accessory and there are public data and private data corresponding to the electronic accessory. As such, when the user uses the electronic device such as a desktop tablet computer, he or she only needs to attach the electronic accessory on the surface of the touch unit of the electronic device. Now, when the electronic accessory has been attached on the surface of the touch unit, the electronic device verifies the electronic accessory, and if the verification is successful, the electronic device controls a display unit to display the public data and the private data, otherwise the electronic device controls the display unit to display only the public data. Therefore, when the electronic accessory attached on the electronic device is not matched with the electronic device, the electronic device will not display the private data corresponding to the electronic accessory so as to prevent the private data from being peeped, efficiently address the technical problem in the prior art of the low security for displaying data due to the indistinguishable data display of the electronic device, improve the security of the data upon displaying and provide a good user experience.

One with ordinary skills in the art should understand that the embodiments of the invention can be provided as methods, systems or computer program products. Accordingly, the invention may take the form of full hardware embodiment, full software embodiment or embodiment combining software and hardware aspects. Furthermore, the invention may take the form of computer program product implemented on one or more computer-usable storage mediums (comprises but does not limit to magnetic disks, CD-ROM, optical memories, etc.) having computer-usable program code embodied.

The invention was described referring to the flowcharts and/or block diagrams of the methods, the devices (systems), and the computer program products according to the embodiment of the invention. It should be understood that each flow and/or block in the flowcharts and/or block diagrams, and the combination of the flows and/or blocks in the flowcharts and/or block diagrams may be implemented by computer program instructions. These computer program instructions may be provided to a general purpose computer, a special purpose computer, a embedded processor or the processors of other programmable data processing devices to product a machine, so that the instructions executed by the computers or the processors of other programmable data processing devices produce an apparatus for implementing the functions specified in one or more flows in the flowcharts and/or one or more blocks in the block diagrams.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in one or more flows in the flowcharts and/or one or more blocks in the block diagrams.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the function specified in one or more flows in the flowcharts and/or one or more blocks in the block diagrams.

Obviously, one with ordinary skills in the art can make alterations and modifications without departing from the spirit and scope of the invention. As such, if these alterations and modifications of the invention fall into the scope of the claims of the invention and equivalents thereof, the invention intends to contain these alterations and modifications.

We claim:

1. A data display method applied to an electronic device, wherein the electronic device comprises a display unit and a touch unit, the electronic device being able to communicate data with an electronic accessory, there being public data and private data corresponding to the electronic accessory, the method comprising:
verifying the electronic accessory when the electronic accessory has been attached on the surface of the touch unit; and
controlling the display unit to display both the public data and the private data if the verification is successful; and
controlling the display unit to display only the public data if the verification is not successful.

2. The method of claim 1, verifying the electronic accessory comprises:
obtaining an accessory identity of the electronic accessory by coupling the touch unit with the electronic accessory;
verifying whether the accessory identity of the electronic accessory is matched with a device identity of the electronic device based on the correspondences between accessory identities and device identities, wherein the verification for the electronic accessory is successful when the accessory identity of the electronic accessory matches with the device identity of the electronic device; and the verification for the electronic accessory is not successful when the accessory identity of the electronic accessory does not match with the device identity of the electronic device.

3. The method of claim 1, wherein after controlling the display unit to display only the public data, the method further comprises:
obtaining a user operation; and
controlling the display unit to display the private data when the obtained user operation meets a predefined condition.

4. The method of claim 1, wherein controlling the display unit to display both the public data and the private data comprises: according to an attachment location where the electronic accessory is attached to the touch unit, controlling the display unit to display both the public data and the private data in a first area containing the attachment location.

5. The method of claim 2, wherein controlling the display unit to display both the public data and the private data comprises: according to an attachment location where the electronic accessory is attached to the touch unit, controlling the display unit to display both the public data and the private data in a first area containing the attachment location.

6. The method of claim 3, wherein controlling the display unit to display both the public data and the private data comprises: according to an attachment location where the electronic accessory is attached to the touch unit, controlling the display unit to display both the public data and the private data in a first area containing the attachment location.

7. The method of claim 1, wherein controlling the display unit to display only the public data comprises: controlling the display unit to display only the public data in a first area according to the attachment location where the electronic accessory is attached to the touch unit.

8. The method of claim 2, wherein controlling the display unit to display only the public data comprises: controlling the display unit to display only the public data in a first area according to the attachment location where the electronic accessory is attached to the touch unit.

9. The method of claim 3, wherein controlling the display unit to display only the public data comprises: controlling the display unit to display only the public data in a first area according to the attachment location where the electronic accessory is attached to the touch unit.

10. An electronic device, wherein the electronic device comprises a display unit and a touch unit, the electronic device being able to communicate data with an electronic accessory, there being public data and private data corresponding to the electronic accessory, the electronic device further comprising:
a verification unit configured to verify the electronic accessory when the electronic accessory has been attached on the surface of the touch unit; and
a control unit configured to control the display unit to display both the public data and the private data if the verification is successful, and, to control the display unit to display only the public data if the verification is not successful.

11. The electronic device of claim 10, wherein the verification unit is further configured to: obtain an accessory identity of the electronic accessory by coupling the touch unit to the electronic accessory; verify whether the accessory identity of the electronic accessory is matched with a device identity of the electronic device based on the correspondences between accessory identities and device identities, wherein the verification for the electronic accessory is successful when the accessory identity of the electronic accessory matches with the device identity of the electronic device, and the verification for the electronic accessory is not successful when the accessory identity of the electronic accessory does not match with the device identity of the electronic device.

12. The electronic device of claim 10, wherein the electronic device further comprise:
an operation obtaining unit configured to, after controlling the display unit to display only the public data, obtain a user operation; and
the control unit is further configured to control the display unit to display the private data when the obtained user operation meets a predefined condition.

13. The electronic device of claim 10, wherein the control unit is configured to, according to an attachment location where the electronic accessory is attached to the touch unit, control the display unit to display both the public data and the private data in a first area containing the attachment location.

14. The electronic device of claim 11, wherein the control unit is configured to, according to an attachment location where the electronic accessory is attached to the touch unit, control the display unit to display both the public data and the private data in a first area containing the attachment location.

15. The electronic device of claim 12, wherein the control unit is configured to, according to an attachment location where the electronic accessory is attached to the touch unit, control the display unit to display both the public data and the private data in a first area containing the attachment location.

16. The electronic device of claim 10, wherein the control unit is configured to control the display unit to display only the public data in the first area according to the attachment location.

17. The electronic device of claim 11, wherein the control unit is configured to control the display unit to display only the public data in the first area according to the attachment location.

18. The electronic device of claim 12, wherein the control unit is configured to control the display unit to display only the public data in the first area according to the attachment location.
